(19) United States
(12) Patent Application Publication
(10) Pub. No.: US 2005/0109072 A1
(43) Pub. Date: May 26, 2005

(54) Double locking device

(76) Inventors: Renny Tse-Haw Ling, Taipei Hsien (TW); Yung-Li Kuo, Taipei Hsien (TW); Cheng-Horng Wu, Taipei Hsien (TW)

Correspondence Address: BIRCH STEWART KOLASCH & BIRCH, PO BOX 747, FALLS CHURCH, VA, 22040-0747, US

(21) Appl. No.: 10/717,577

(22) Filed: Nov. 21, 2003

(51) Int. Cl. E05B 67/38

(52) U.S. Cl. 70/68

(57) ABSTRACT

A double locking device includes two identical sliders movable close to or separate from one another. The slider has a sliding dock and a latch lock located on the sliding dock. The sliding docks of the two sliders may be moved close to each other and the latch locks may be latched securely through movable hooks. The latch lock is controllable for switching to an unlocking condition or a locking condition. In the unlocking condition, the movable hooks may be moved to a separation position so that the movable hooks release the latching relationship. In the locking condition the two movable hooks cannot be moved in order to maintain the latching relationship and prevent the two sliders from being separated.

### FIELD OF THE INVENTION

The invention relates to a double locking device that uses a key or numeric combination mechanical device to lock or unlock two members such as a pair of zipper sliders so that they may be latched together or separated to close or open the zipper.

### BACKGROUND OF THE INVENTION

Zipper locks are well known in the art. Reference can be found in U.S. Pat. Nos. 4,221,027, 4,262,502, 4,271,689, 4,578,966, 4,930,323, 4,951,485, 5,063,760, 5,103,657, 6,062,051, etc. These zipper locks are widely used in products of trunks and bags such as hang bags, luggage, or carrying cases. When two sliders are moved close to each other, they may be locked by the zipper lock to prevent from separating so that the luggage or cases cannot be opened without proper authorization.

There are many types of zipper locks available on the market. Some are individual zipper locks in which two sliders are moved close to each other and the pull tabs are coupled on the zipper lock for fastening. Such a zipper lock is an independent item. When it is removed from the sliders, it is often disposed separately and prone to being lost. Hence it is not a desirable design.

There is another type of zipper lock in which the lock structure is directly built in a slider. When two sliders are moved close to each other, the slider equipped with the lock structure can latch on the other slider to create coupling without separation. While it is easier to use, the slider has size limitations, and thus cannot accommodate a more complicated lock structure. It usually adopts a simpler key lock or combination lock. For instance, U.S. Pat. No. 4,578,966 discloses such a slide fastener that employs a key lock, and U.S. Pat. No. 4,951,485 discloses a dial lock for slide fasteners. Consumers can select different types of zipper locks according to their requirements. For the slider equipped with a key lock, users still have to carry a key, which is not convenient. Hence in the market, the slider with a built-in combination lock is more popular.

Take U.S. Pat. No. 4,951,485 as an example. It has a dial ring on the slider. One of the marked numbers on the dial ring is set as the unlocking number. The number of attempt to unlock is X¹ (where X is the number set on the dial ring). For instance, with ten marks 0-9 on the dial ring, 10¹ is 10 times. That is, the dial lock may be unlocked by turning a maximum of ten times. This is not effective to meet the design purpose. Moreover, there are often two movable sliders on the luggage zipper, with only one slider equipped with the lock structure, and only one latch hook is provided to latch another slider. Hence the two sliders form only one kind of latching relationship. They are easily unfastened by incidental impact during transportation of the luggage. They are easily broken and separated by malicious hitting.

In addition, from the prospective of zipper producers, the slider equipped with a lock structure is different from those that are not. Different specifications of elements have to be prepared for fabrication, and different production processes have to be set up. All this complicates the design and production.

### SUMMARY OF THE INVENTION

In view of the aforesaid disadvantages of the conventional zipper designs that have a dial lock built into one slider, the invention provides a modular slider design that has two corresponding sliders forming a double locking device that makes unauthorized unlocking more difficult and enhances the latching relationship of the two sliders.

The double locking device according to the invention includes two identical sliders that are movable relative to one another on two sides of a zipper, and may be close to each other or separated to open or close the zipper. One of the sliders may be stationary, and the other slider movable to close or open the zipper. The slider includes a sliding dock and a latch lock. The sliding dock is movable on the zipper. The latch lock is located in the sliding dock. The latch lock has a movable hook and a lock assembly. The lock assembly may be controlled and switched to an unlocking condition or a locking condition. When the two sliders are close to each other, the movable hook of one slider can latch the latch lock of the other slider. When the lock assembly is in the unlocking condition, the movable hook may be moved to a separation position to release the latching relationship of the two movable hooks and the two sliders may be separated. When the lock assembly is in locking condition, the two movable hooks cannot be moved and maintain the latching relationship, and the two sliders cannot be separated.

The double locking device according to the invention has two corresponding sliders of the same structure and two lock assemblies. Taking the dial lock as an example, the two lock assemblies provide an unlocking probability that is twice the involution of the number being set. Thus it significantly increases the difficulty of unauthorized unlocking. Moreover, the two sliders can latch with each other and improve the coupling relationship to withstand greater impact force, and are therefore more suitable for travelling luggage.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1A and 1B are perspective views of a first embodiment of the invention.

FIGS. 2A and 2B are exploded views of the first embodiment of the invention, including details of the sliders.

FIGS. 3A, 3B and 3C are schematic views of the first embodiment of the invention in operating conditions, with two sliders coupled and separated.

FIGS. 4A, 4B and 4C are schematic views of a second embodiment of the invention.

### DESCRIPTION OF THE PREFERRED EMBODIMENTS

The double locking device according to the invention is adopted for products that have zippers such as trunks and bags that include hang bags, luggage, or carrying cases, and particularly to luggage or travelling cases that require zippers equipped with latch locks to prevent unauthorized opening.

### First Embodiment

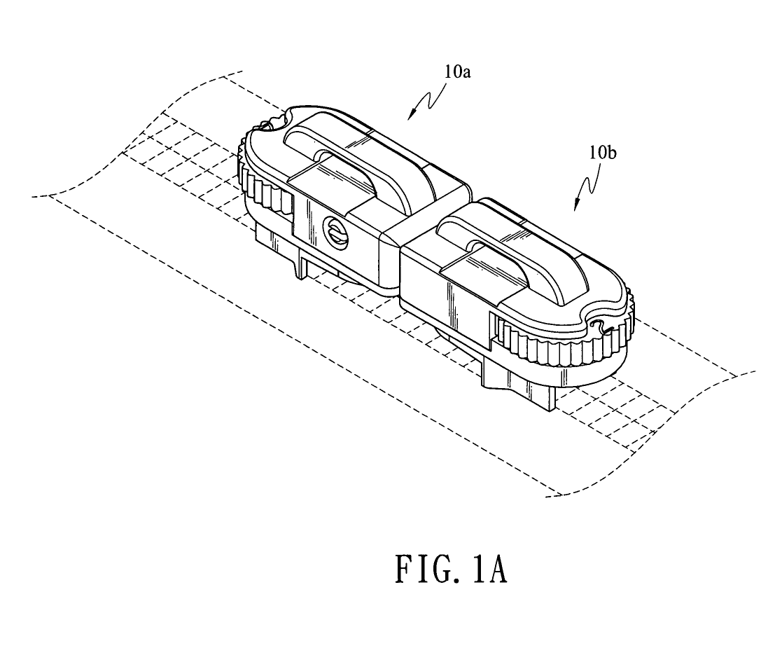

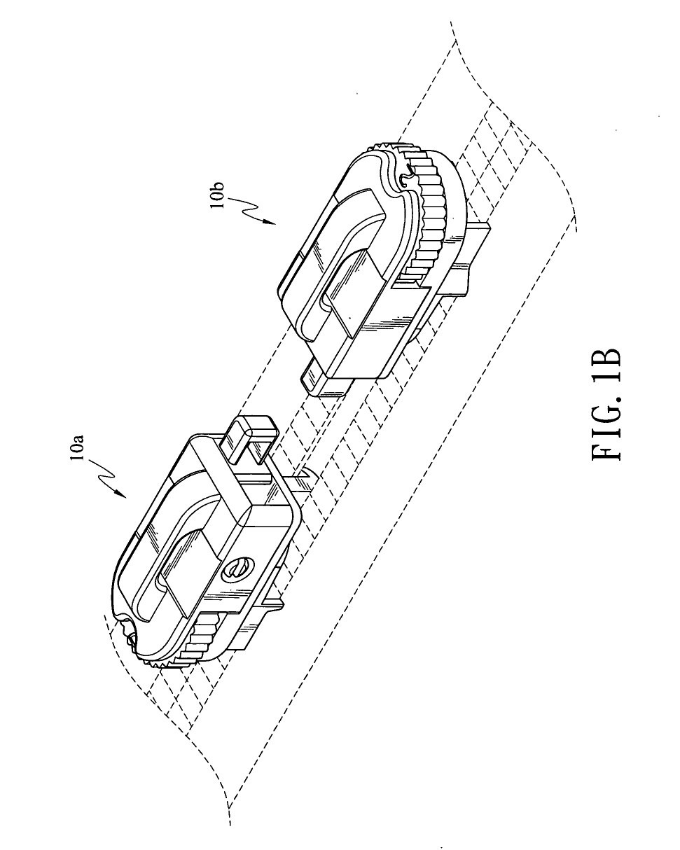

Referring to FIGS. 1A and 1B, the double locking device according to the invention includes two sliders 10a and 10b that have the same structure. The two sliders 10a and 10b are movable on two sides of a zipper (shown by broken lines in the drawings) and correspond to each other. The two sliders 10a and 10b may be moved close to each other or separated to close or open the zipper. As the two sliders 10a and 10b are identically constructed, only the details of the slide 10a will be discussed as follows, and will be marked by “10” for identification.

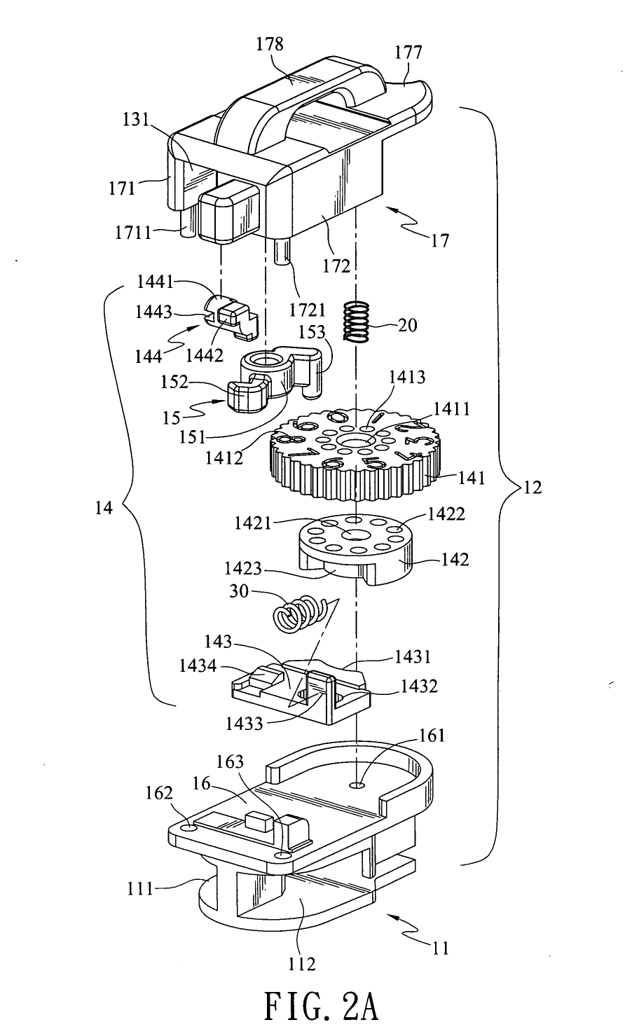

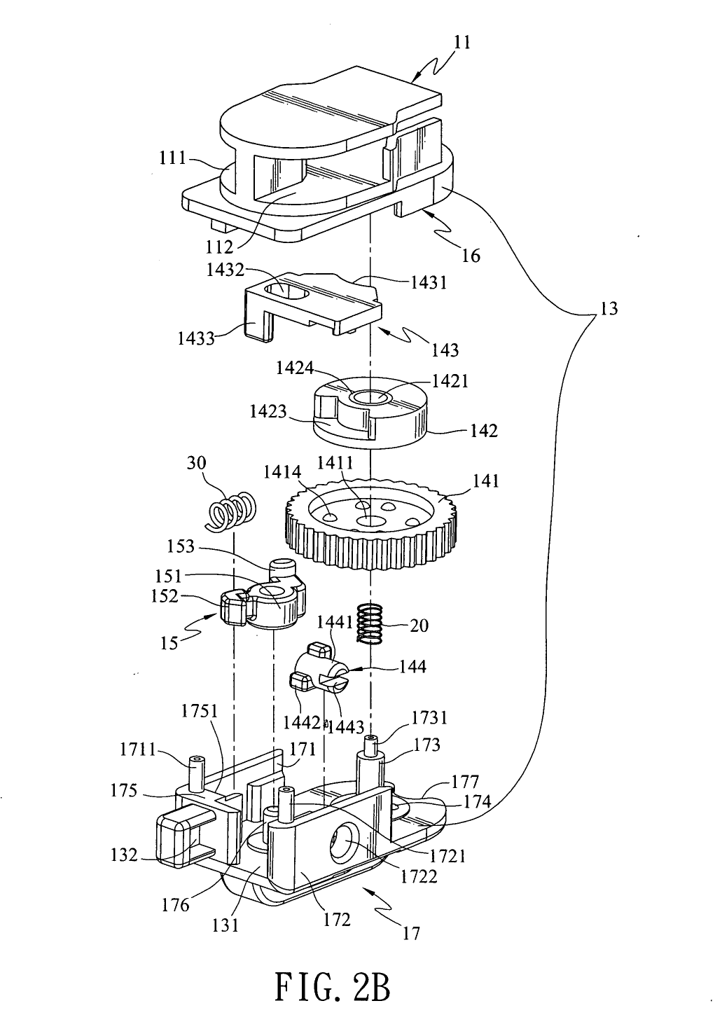

Referring to FIGS. 2A and 2B, the slider 10 includes a sliding dock 11 and a latch lock 12. The sliding dock 11 has a cross section in an I-shape to form two sliding channels 111 and 112 to couple with two sides of the zipper so that when the sliding dock 11 is moved on the two sides of the zipper, the zipper may be closed or opened.

The latch lock 12 is located on the sliding dock 11 and is movable with the sliding dock 11 on the two sides of the zipper. The latch lock 12 includes a shell 13, a lock assembly 14 and a movable hook 15. The shell 13 includes a base plate 16 and a cap 17. The base plate 16 has one rectangular end and one semi-circular end. The semi-circular end of the base plate 16 has an anchor hole 161, while the other end has two anchor holes 162 and 163. The cap 17 is formed to mate with the base plate 16. The rectangular end of the cap 17 has two walls 171 and 172 extending vertically from two sides to connect to the base plate 16 and form a housing space between the cap 17 and the base plate 16. The semi-circular end is not sealed. The semi-circular end of the cap 17 has an axle 173 on the same side of the walls 171 and 172. The axle 173 is surrounded by a plurality of sensing stubs 174. The top end of the axle 173 has a pin 1731 corresponding to the anchor hole 161. The rectangular end abutting the wall 171 has a vertical wall 175 with a width one half of the rectangular end so that when the cap 17 and the base plate 16 are coupled, the edge of the rectangular end forms an opening 131. The wall 175 is extended to form a hook 132. The wall 175 has another side corresponding to the hook 132 and forming a bucking surface 1751.

The center of the rectangular end of the cap 17 has a coupling strut 176. The walls 171 and 172 have pins 1711 and 1721 corresponding to the anchor holes 162 and 163. Moreover, the wall 172 has a round hole 1722. The semi-circular end of the cap 17 has an indented viewing window 177 adjacent to the peripheral end. The cap 17 further has a coupling ring 178 located on another side corresponding to the walls 171 and 172. The coupling ring 178 is coupled with a pull tab (not shown in the drawing) to be grasped by users for moving the slider 10.

The lock assembly 14 includes a dial ring 141, a locking wheel 142, a latch 143 and an alteration pin 144. The dial ring 141 has a diameter substantially the same as the semi-circular end of the cap 17, has teeth formed on the perimeter to facilitate turning for users, and has an aperture 1411 in the center to couple with the axle 173 to facilitate turning by users. One side of the dial ring 141 has ten numeric marks 1412 formed in an annular manner ranging from 0 to 9. The dial ring 141 further has sensing cavities 1413 abutting the center corresponding to the numeric marks 1412. The dial ring 141 is coupled to the axle 173 on the side where the numeric marks 1412 located, with the sensing cavities 1413 coupling with the sensing stubs 174 on the periphery of the axle 173. When the dial ring 141 is turned, the sensing cavities 1413 can detect the sensing stubs 174 to confirm the location of the corresponding numeric marks 1412 of the dial ring 141. The dial ring 141 has another side which is opposite the numeric marks 1413 and that has a plurality of anchor bosses 1414.

The locking wheel 142 has a diameter smaller than the dial ring 141, and has a hole 1421 in the center to couple on the axle 173 so that the locking wheel 142 is in contact with the dial ring 141. The hole 1421 has an inner rim 1424. The locking wheel 142 has anchor cavities 1422 on one side corresponding to the anchor bosses 1414 of the dial ring 141 that oppose the numeric marks 1412. The locking wheel 142 further has a recess 1423 on another side opposing the anchor cavities 1422.

The latch 143 is movable in the cap 17 corresponding to where the locking wheel 142 is located. The latch 143 has a head end 1431, which is formed substantially mating with the recess 1423. When the locking wheel 142 is turned with the dial ring 141 and the recess 1423 corresponds to the head end 1431 of the latch 143, the latch 143 moves towards the recess 1423 with the head end 1431 entering the recess 1423. The latch 143 has a coupling hole 1432, a first retaining member 1433 and a second retaining member 1434. The first retaining member 1433 is located on another side of the latch 143 at one end opposing the head end 1431 and corresponding to the wall 175 of the cap 17. The second retaining member 1434 is located on another side of the coupling hole 1432.

The alteration pin 144 consists of a shaft 1441 and a retaining strut 1442. The shaft 1441 is housed in the round hole 1722 of the wall 172 and is turnable therein. The shaft 1441 has one end forming a latch notch 1443 to enable users to turn the alteration pin 144 with a hand tool. The alteration pin 144 has at least a first position where the retaining strut 1442 is in contact with the second retaining member 1434 of the latch 143, and a second position where the retaining strut 1442 is not in contact with the second retaining member 1434 of the latch 143.

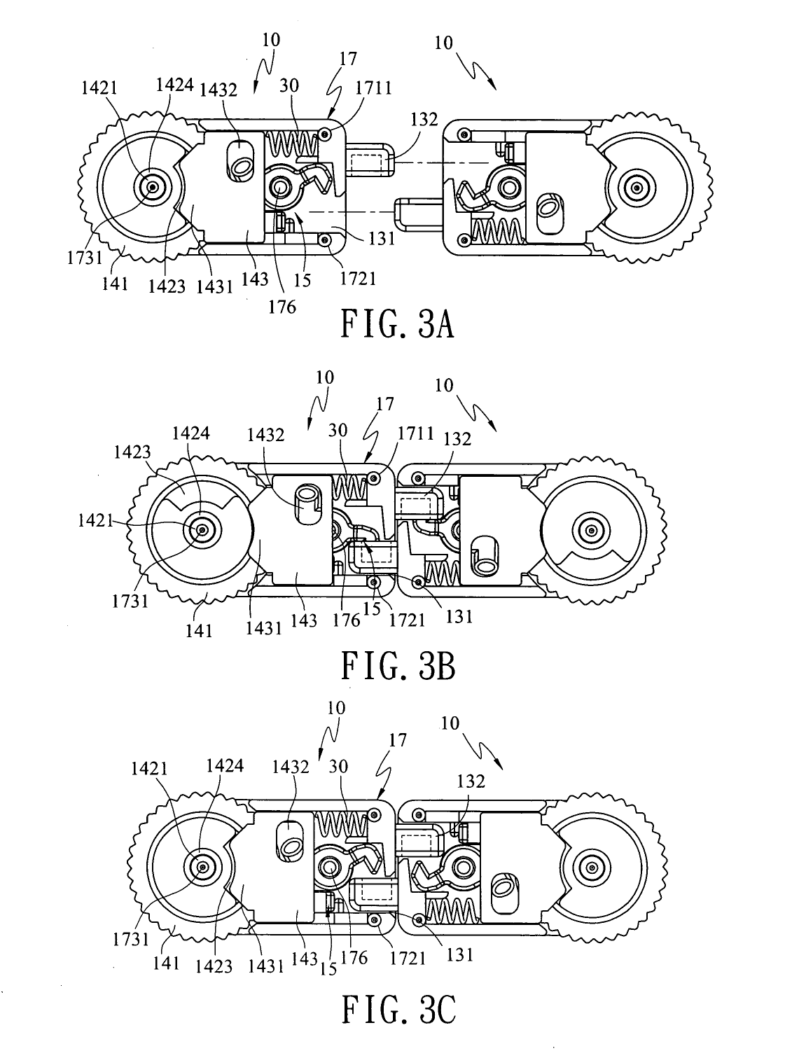

To assemble the lock assembly 14, couple the dial ring 141 on the axle 173, with the numeric marks 1412 corresponding to the cap 17, and the sensing cavities 1413 of the dial ring 141 coupling with the sensing stubs 174 of the axle 173. Then couple the locking wheel 142 on the axle 173, with the anchor cavities 1422 coupling on the anchor bosses 1414 of the dial ring 141. Dispose a spring 20 to press the inner rim 1424 of the locking wheel 142 so that the dial ring 141 and the locking wheel 142 are in contact with each other and are in contact with the cap 17. Turn the dial ring 141 to drive the locking wheel 142 to rotate. There is a spring 30 between the first retaining member 1433 of the latch 143 and the bucking surface 1751 on the wall 175. The elastic force of the spring 30 enables the latch 143 to press the locking wheel 142. When the recess 1423 of the locking wheel 142 faces the latch 143, the head end 1431 of the latch 143 enters the recess 1423 to form an “unlocking condition” of the lock assembly 14 (as shown in FIG. 3C). As the numeric marks 1412 of the dial ring 141 are masked by the cap 17, only one of the numeric marks 1412 is shown in the viewing window 177 of the cap 17. The exposed numeric mark is the unlocking number. When the head end 1431 of the latch 143 leaves the recess 1423 and presses the perimeter of the locking wheel 142, the lock assembly 14 is in a “locking condition” (as shown in FIG. 3B).

After the lock assembly 14 has been assembled, the alteration pin 144 is located on the second position. The number corresponding to the unlocking condition for the lock assembly 14 is set. However, users still can change the unlocking number through the alteration pin 144. If the user wants to change the unlocking number, first, the lock assembly 14 has to be in the unlocking condition, i.e. the head end 1431 of the latch 143 enters the recess 1423 of the locking wheel 142, then the alteration pin 144 is turned to the first position to press the retaining strut 1442 of the alteration pin 144 on the second retaining member 1434 of the latch 143 so that the head end 1431 of the latch 143 cannot escape the recess 1423. The dial ring 141 may be turned to extend the head end 1431 of the latch 143 into the recess 1423 of the locking wheel 142, the locking wheel 142 cannot be turned with the dial ring 141, and the anchor bosses 1414 of the dial ring 141 passes over the anchor cavities 1422 of the locking wheel 142. When the dial ring 141 is turned and another one of the numeric marks 1412 is shown in the viewing window 177 of the cap 17, the anchor bosses 1414 of the dial ring 141 are coupled with the anchor cavities 1422 of the locking wheel 142 again, and the alteration pin 144 may be moved to the second position. The number exposed in the viewing window 177 is the new unlocking number. Hence changing the number is accomplished by forced separation of the dial ring 141 and the locking wheel 142 to alter the relative anchor position of the two.

The movable hook 15 includes a sleeve 151, latch hooks 152 on two sides of the sleeve 151 and a connection strut 153. The sleeve 151 may be coupled on the coupling strut 176 of the cap 17 to enable the movable hook 15 to be coupled on the cap 17 in a turnable manner. The connection strut 153 of the movable hook 15 is inserted into the coupling hole 1432 of the latch 143. The coupling hole 1432 is substantially a rectangular slot. When the latch 143 is moved, the coupling hole 1432 pushes the connection strut 153 so that the movable hook 15 may be turned about the sleeve 151 and the latch 143 can drive the movable hook 15 to turn, so that the latch hooks 152 of the movable hook 15 have a “separation position” corresponding to the unlocking condition of the lock assembly 14, and a “latch position” corresponding to the locking condition of the lock assembly 14.

After the lock assembly 14 and the movable hook 15 have been assembled on the cap 17, couple the base plate 16 and the cap 17. The anchor holes 161, 162 and 163 are coupled with the pins 1711, 1721 and 1731 to complete the assembly of the latch lock 12.

Referring to FIGS. 3A, 3B and 3C, the two sliders 10 are located on two opposite sides of the zipper (not shown in the drawings), and are identical. When the lock assemblies 14 of the two sliders 10 are in the unlocking condition, the movable hooks 15 are at the separated positions. When the two sliders 10 are moved close to each other, the hook 132 of the sliders 10 goes into the latch lock 12 through the opening 131. When turning the dial ring 141, the lock assembly 14 is changed to the locking condition, and the movable hooks 15 are moved to the latch position. Thus the movable hooks 15 and the hooks 132 of the two sliders 10 are latched to each other to couple the two sliders 10 securely. By means of the double locking device of the invention, the two sliders 10 each have a lock assembly 14, the number of attempts to unlock is X² (where X is the number set on the dial ring). For instance, if the numeric marks 1412 on the dial ring 141 are set 0-9, then 10² is 100. That is, the probability of unauthorized attempt for unlocking decreases (with different unlocking numbers set for the two lock assemblies 14). Moreover, the movable hook 15 and the hook 132 may be latched with each other to enable the two sliders 10 to form a firmer coupling to withstand greater external impact.

In the locking condition, the two sliders 10 cannot be separated. When separating the two sliders 10, the dial rings 141 of the two lock assemblies 14 must be turned to the unlocking numbers first to move the movable hooks 15 to the separation position. Then the two sliders 10 may be separated.

In addition, in this embodiment one of the sliders 10 may be stationary. Closing or separating movement is accomplished by another slider 10.

### Second Embodiment

In the first embodiment set forth above, the lock assembly 14 has one dial ring 141, and two lock assemblies 14 provide X² times of unlocking combinations (where X is the number set on the dial ring). According to the double locking device of the invention, the number of the dial ring 141 in the lock assembly 14 may be increased to increase unlocking combinations and reduce the probability of unauthorized unlocking.

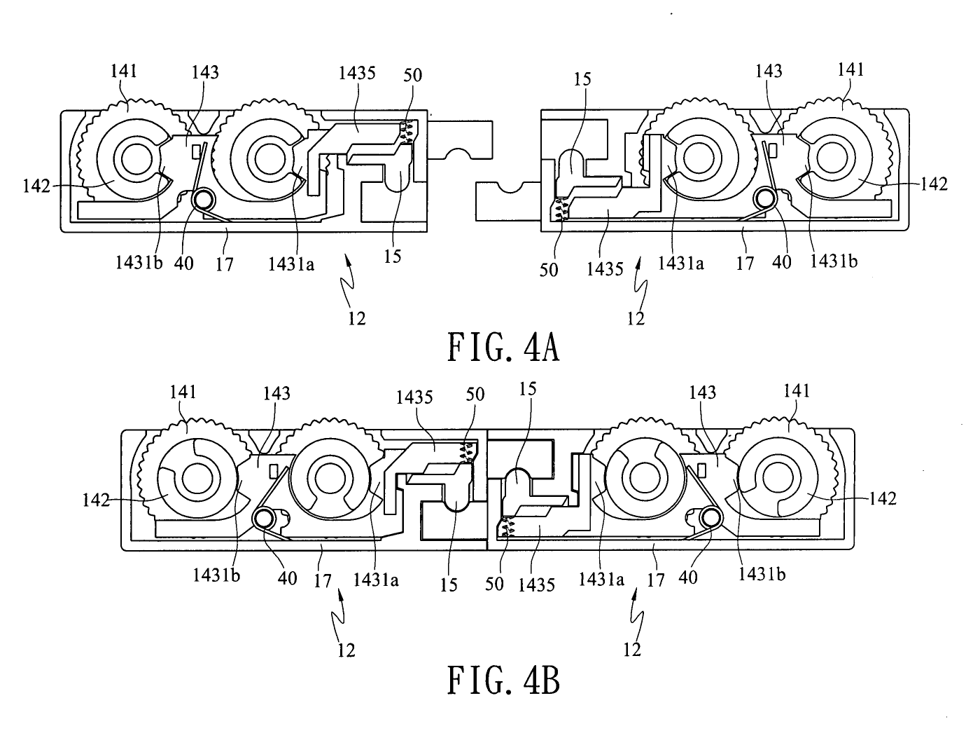

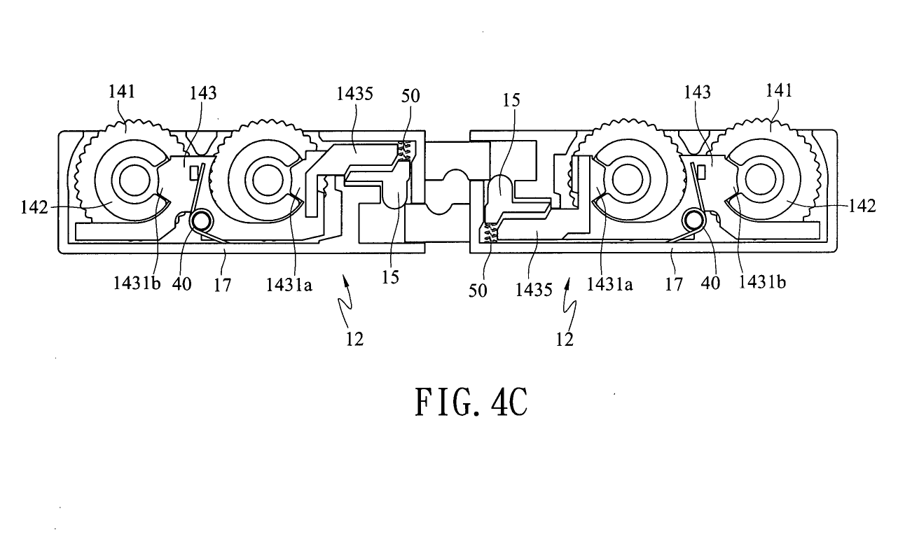

Referring to FIGS. 4A, 4B and 4C, the latch lock 12 in the cap 17 has two juxtaposed dial rings 141 and locking wheels 142 (the operation principle is the same as the first embodiment, thus details are omitted; only the differences are elaborated herein). The latch 143 has two head ends 1431a and 1431b corresponding to the two locking wheels 142. A torsional spring 40 is disposed between the latch 143 and the cap 17 to provide a force to move the latch 143 towards the locking wheels 142. The movable hook 15 is located in the cap 17 and may be moved transversely. There is a bucking member 1435 located between the latch 143 and the movable hook 15. Another spring 50 is provided to push the movable hook 15 to the latch position (in normal conditions). In the unlocking condition, the bucking member 1435 is separated from the movable hook 15, so that the movable hook 15 may be moved by force to resist the spring 50 to the separation position. In the locking condition, the bucking member 1435 presses the movable hook 15 so that the movable hook 15 cannot be moved from the latch position to the separation position.

By providing two sets of unlocking number in one slider 10, the two sliders 10 provide four sets of unlocking numbers. The unlocking combination is X⁴ times. Thus it can reduce the probability of unauthorized unlocking.

According to the double locking device of the invention, the unlocking or locking number of the slider 10 may be set freely as desired. For instance, in the embodiments set forth above, there are one to one and two to two unlocking combinations. It can also be arranged to have one dial ring 141 on one slider 10, and two dial rings 141 on another slider 10 to provide a one to two unlocking combination. Of course, it is also allowable to provide a one to three or two to three combination, or the like. In addition, the numeric marks 1412 on the dial ring 141 may have two or more unlocking numbers so that the unlocking combination and unlocking number combination may be altered as desired to form multiple types of double locking devices.

While the preferred embodiments of the invention have been set forth for the purpose of disclosure, modifications of the disclosed embodiments of the invention as well as other embodiments thereof may occur to those skilled in the art. Accordingly, the appended claims are tended to cover all embodiments which do not depart from the spirit and scope of the invention.

1. A double locking device comprising two identical sliders movable to close to and separate from one another, each of the sliders having a latch lock and a sliding dock, the latch lock having a hook, a lock assembly and a movable hook, the lock assembly being alterable to an unlocking condition and a locking condition, the movable hook of one of the two sliders being located at a separation position in the unlocking condition for disengaging the moveable hook of the one of the two sliders with the hook of the other one of the two sliders and at a latch position in the locking condition for engaging the moveable hook of the one of the two sliders with the hook of the other one of the two sliders, the two sliders being close to each other when the movable hooks of the latch locks are at the latch position to latch the hooks.

2. The double locking device of claim 1, wherein the lock assembly includes at least one dial ring, one locking wheel and a latch, the locking wheel being located on the dial ring and turnable with the dial ring, and having a recess corresponding to the dial ring at a location where a numeric mark is formed, the latch being movably located on the latch lock and linking to the movable hook to press the slider to keep the movable hook at the latch position, the locking wheel being turnable such that the latch enters the recess to drive the movable hook to the separation position.

3. The double locking device of claim 2, further having a spring bucking the latch to push the latch towards the locking wheel.

4. The double locking device of claim 1, wherein one of the sliders is stationary and the other one of the sliders is movable close to or separate from the stationary slider.

5. The double locking device of claim 1, wherein the movable hook and the hook is latched to each other at the latch position.

6. A latch lock structure located on a sliding dock for coupling a corresponding latch lock structure and locking the latch lock structure and the corresponding latch lock structure, comprising:
a shell having a hook;
a lock assembly located in the shell controllable to switch to an unlocking condition or a locking condition; and
a movable hook movably located in the shell to couple with the lock assembly, the moveable hook having a release position corresponding to the unlocking condition for disengaging the moveable hook with a corresponding hook of the corresponding latch lock structure and a latch position corresponding to the locking condition for engaging the moveable hook with the corresponding hook of the corresponding latch lock structure.

7. The latch lock structure of claim 6, wherein the lock assembly includes at least one dial ring, at least one locking wheel and a latch, the locking wheel being located on the dial ring and turnable with the dial ring, and having a recess corresponding to the dial ring at a location where a numeric mark is formed, the latch being movably located on the latch lock structure and linking to the movable hook to keep the movable hook at the latch position, the locking wheel being turnable such that the latch enters the recess to drive the movable hook to the release position.

8. The latch lock structure of claim 7 further having a spring bucking the latch to push the latch towards the locking wheel.
